(19) United States
(12) Patent Application Publication
(10) Pub. No.: US 2017/0063997 A1
(43) Pub. Date: Mar. 2, 2017

(54) EVALUATION APPARATUS, EVALUATION SYSTEM, DEVICE, AND EVALUATION METHOD

(71) Applicant: HITACHI, LTD., Tokyo (JP)

(72) Inventors: Yuncheng ZHU, Tokyo (JP); Hideki OKITA, Tokyo (JP); Seishi HANAOKA, Tokyo (JP)

(73) Assignee: HITACHI, LTD., Tokyo (JP)

(21) Appl. No.: 15/234,798

(22) Filed: Aug. 11, 2016

(30) Foreign Application Priority Data
Aug. 26, 2015 (JP) 2015-166892

(51) Int. Cl. H04L 29/08; G01M 17/007; G07C 5/08; G01M 99/00; B25J 9/16

(52) U.S. Cl. CPC H04L 67/12; G01M 99/008; B25J 9/1674; G07C 5/0808; G01M 17/007; G05B 2219/39412

(57) ABSTRACT

An evaluation apparatus includes: a processor; a memory; and an interface configured to receive data output by devices. The processor being configured to: receive action indicators including indicative data representing at least one physical quantity measured by a device and indicative data representing at least one specific of an action performed by the device through the interface; store the received action indicators to the memory; presume the action of the device by finding a match through comparing the received action indicators with templates each specifying a combination of items of indicative data required to presume an action of the devices; extract indicative data required to evaluate the presumed action from the received action indicators; and evaluate quality of the presumed action based on the extracted indicative data.

### CLAIM OF PRIORITY

The present application claims priority from Japanese patent application JP 2015-166892 filed on Aug. 26, 2015, the content of which is hereby incorporated by reference into this application.

### BACKGROUND

This invention relates to an evaluation apparatus, an evaluation system, a device, and an evaluation method.

Advancement of communication technology allows diverse devices other than the existing information-related devices to connect to the Internet. The technology for all devices to exchange information via the Internet is called IoT (Internet of Things) and the devices having connection functionality are called IoT devices. The IoT devices have widely spread to become a part of the social infrastructure and the quality of action of the IoT devices links with the quality of life of people; it is essential to guarantee the quality of action of the IoT devices.

Evaluating the quality of action of each IoT device enables prevention of occurrence of an IoT failure and further, enables preparation of a maintenance plan before occurrence of a failure in an IoT device.

Techniques to evaluate the quality of action of an IoT device include a method of examining a virtual living thing via a network. There has been proposed a method that sends data necessary to evaluate the condition of software or hardware of a virtual living thing via a communication channel and evaluates the condition of the virtual living thing based on the result of analyzing diagnostic data (for example, refer to JP 2001-282570 A).

Techniques to evaluate handling of an IoT device include a method of evaluating the handling of a vehicle. There has been proposed a vehicle operation evaluation method that acquires driving data of a vehicle and information on the environment around the vehicle when the driving data is acquired, extracts a history of driving data acquired in the similar environment to the environment when the driver operates the vehicle, and evaluates the driver's operation of the vehicle based on the acquired driving data and the extracted history of driving data (for example, JP 2013-003887 A).

There has been proposed another technique that holds multiple templates created by categorizing driving action patterns designated from accumulated data and compares acquired driving data with the templates to predict the action of the driver at a guidance point (for example, JP 2006-133216 A)

### SUMMARY

The technique to evaluate the quality of action of an IoT device as disclosed in JP 2001-282570 A requires that the IoT device interrupts working and performs actions specified by the evaluation program to create diagnostic data. Accordingly, the interruption generates loss cost during the evaluation processing, which makes frequent evaluation difficult.

The technique to evaluate the handling of an IoT device as disclosed in JP 2013-003887 A can evaluate the appropriateness of the operation of the IoT device using the environmental data and operating data without stopping the working of the IoT device. However, this technique can evaluate a specific operation of the vehicle but cannot change the evaluation method for a plurality of different operations of the vehicle. Accordingly, even if this technique is applied to evaluating the quality of action of an IoT device, sophisticated evaluation is difficult.

This is because, in evaluating the quality of action of an IoT device, the evaluation method needs to be changed depending on the kind of action of the IoT device. For example, some of the components of the IoT device exhibit a feature of deterioration as deviation of some diagnostic indicators from their reference values representing normal conditions only when the IoT device is performing a specific action. Accordingly, if all actions are evaluated with the same evaluation method that analyzes the same diagnostic indicators, the above-described feature of deterioration can be included in the noise of the entire diagnostic indicators, so that the method could fail to correctly determine the deterioration in quality of action.

The technique disclosed in JP 2006-133216 A can predict an action of the driver but cannot evaluate the behavior of the vehicle responsive to an action of the driver.

This invention has been accomplished in view of the foregoing issues and aims to determine an IoT device that has deteriorated in quality of action through sophisticated evaluation.

For solving the above problem, an evaluation apparatus according to this invention includes: a processor; a memory; and an interface configured to receive data output by devices. The processor is configured to: receive action indicators including indicative data representing at least one physical quantity measured by a device and indicative data representing at least one specific of an action performed by the device through the interface; store the received action indicators to the memory; presume the action of the device by finding a match through comparing the received action indicators with templates each specifying a combination of items of indicative data required to presume an action of the devices; extract indicative data required to evaluate the presumed action from the received action indicators; and evaluate quality of the presumed action based on the extracted indicative data.

This invention enables determination of a device that has deteriorated in quality of action through sophisticated evaluation. Issues, configurations, and effects other than those described above are clarified in the following description of the embodiments.

### BRIEF DESCRIPTION OF THE DRAWINGS

FIG. 1 is an explanatory diagram for illustrating a configuration of an evaluation system in Embodiment 1;

FIG. 2 is a block diagram for illustrating a configuration of a robot in Embodiment 1;

FIG. 3 is an explanatory diagram for illustrating an example of an actuator information table held by a robot in Embodiment 1;

FIG. 4 is an explanatory diagram for illustrating an example of a sensor information table held by a robot in Embodiment 1;

FIG. 5 is an explanatory diagram for illustrating an example of an action template information table held by a robot in Embodiment 1;

FIG. 6 is an explanatory diagram for illustrating an example of an action indicator information table held by a robot in Embodiment 1;

FIG. 7 is a flowchart for illustrating specific processing of an action indicator sending program of a robot in Embodiment 1;

FIG. 8 is a block diagram for illustrating a configuration of an evaluation apparatus in Embodiment 1;

FIG. 9 is an explanatory diagram for illustrating an example of an environmental indicator information table held by the evaluation apparatus in Embodiment 1;

FIG. 10 is an explanatory diagram for illustrating an example of an action efficiency indicator information table held by the evaluation apparatus in Embodiment 1;

FIG. 11 is an explanatory diagram for illustrating an example of an action indicator history table held by the evaluation apparatus in Embodiment 1;

FIG. 12 is a flowchart for illustrating specific processing of an action quality evaluation program of the evaluation apparatus in Embodiment 1;

FIG. 13 is an explanatory diagram for illustrating an evaluation system in Embodiment 2;

FIG. 14 is a block diagram for illustrating a configuration of an evaluation apparatus in Embodiment 2;

FIG. 15 is an explanatory diagram for illustrating an example of an action template information table held by the evaluation apparatus in Embodiment 2; and

FIG. 16 is a flowchart for illustrating specific processing of an action quality evaluation program of the evaluation apparatus in Embodiment 2.

### DETAILED DESCRIPTION OF THE EMBODIMENTS

Hereinafter, embodiments of this invention will be described using the drawings.

The following description is provided in a plurality of sections or embodiments as necessary for convenience; however, they are not irrelevant to one another unless specified otherwise. One is a modified, detailed, or supplementary example of a part or the entirety of another.

When a specific number (inclusive of number, numerical value, amount, and range) is provided for an element in the following description, the number is not limited to the specific number and may be greater or smaller than the specific number except for explicitly specified cases or cases where the number is obviously limited to the specific number in principle.

Furthermore, each element (inclusive of element steps) in the following description is not indispensable except for explicitly specified cases or cases where the element is obviously indispensable in principle.

Still further, each embodiment in the following description may be applied independently or otherwise, some or all of the embodiments may be combined to be applied.

### Embodiment 1

This embodiment relates to a robot evaluation system including a plurality of robots and an evaluation apparatus for evaluating the quality of each action of each robot. Each robot in this embodiment sends a combination of action indicators to the evaluation apparatus using communication media.

The evaluation apparatus in this embodiment presumes an action pattern of the robot based on the received action indicators, extracts history records of a predetermined combination of action indicators based on the presumption, and determines whether the robot has deteriorated in quality of action based on the received action indicators and the history records.

The action pattern in this embodiment includes at least one action and is a unit of action of the robot. For example, in the case where the action pattern is walk, the action pattern includes an action of lifting the right thigh forward and an action of lowering the right foot to the ground. Although the evaluation apparatus in this embodiment presumes such at least one action of the robot, the following description refers to this operation as presuming an action pattern.

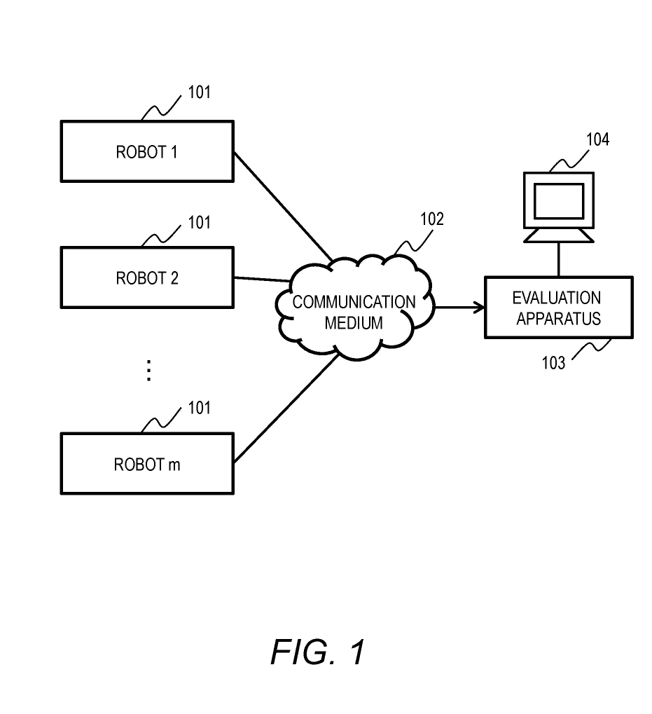

FIG. 1 is an explanatory diagram for illustrating a configuration of the evaluation system in Embodiment 1.

The system in this embodiment includes a plurality of robots 101, communication media 102 for transmitting indicative data of action indicators, an evaluation apparatus 103, and a display apparatus 104.

The evaluation apparatus 103 receives action indicators from each robot 101 via the communication media 102 and determines whether the quality of action of the robot 101 has deteriorated. The evaluation apparatus 103 provides the determination results on the quality of action to the display apparatus 104. The display apparatus 104 has an output device such as a display or a printer.

The robot 101 is an IoT device in Embodiment 1. The robot 101 is a device that works actively. The robot 101 sends action indicators including indicators representing its own action and indicators representing the environment when the robot 101 performs the action to the evaluation apparatus 103.

The communication media 102 can be any means as far as it is capable of relaying a signal. The communication media 102 can be a communication network, a server, or recording media, for example.

In the case where the communication media 102 is a server, the server may receive action indicators from a plurality of robots 101 and provide the received indicators collectively to the evaluation apparatus 103. In the case where the communication media 102 is recording media, each robot 101 may store action indicators to a recording medium and the administrator may store the action indicators to the evaluation apparatus 103 through this recording medium.

The robot 101 may connect to the communication media 102 constantly or only when to send the action indicators.

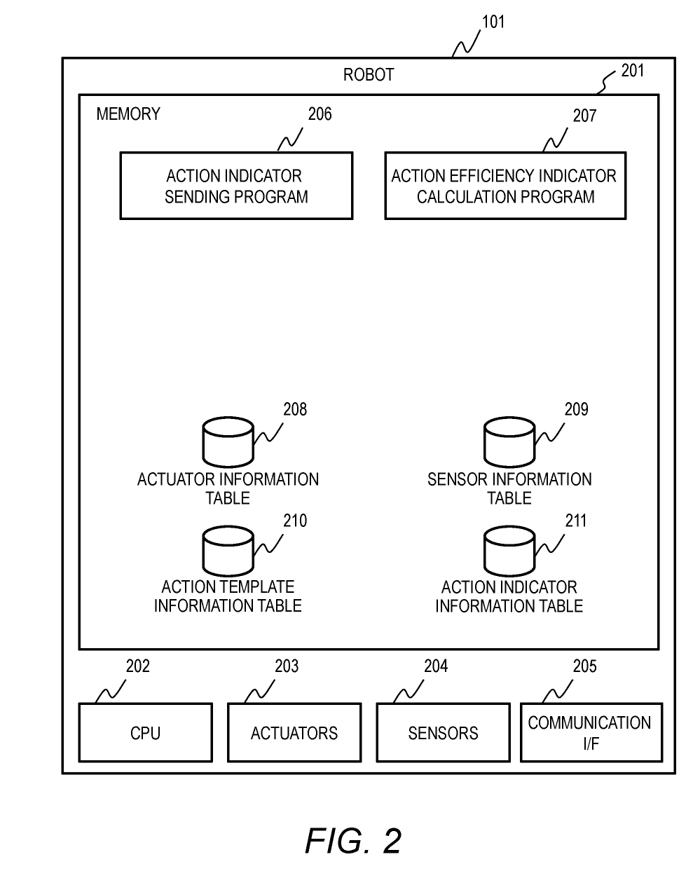

FIG. 2 is a block diagram for illustrating a configuration of a robot 101 in Embodiment 1.

The robot 101 has the functionality of a computer including a memory 201 and a CPU 202. The robot 101 in Embodiment 1 implements functions required for the action quality evaluation with program software or firmware. The CPU 202 of the robot 101 deploys and executes this program software or firmware on the memory 202.

The memory 201 includes a ROM of a non-volatile storage element and a RAM of a volatile storage element. The ROM stores programs that will not be altered (for example, the BIOS). The RAM is a high-speed and volatile storage element like a DRAM (Dynamic Random Access Memory) and stores, on a temporary basis, programs and data to be used to execute the programs stored in an auxiliary storage device.

Specifically, the memory 201 stores an action indicator sending program 206 and an action efficiency indicator calculation program 207. These programs implement function blocks.

The robot 101 further includes actuators 203 for making robotic actions designed by the developer and sensors 204 for measuring information on the exterior environment and the actuators 203, and a communication I/F 205 for connecting to the communication media 102.

The memory 201 of the robot 101 in Embodiment 1 stores an action indicator sending program 206 and an action efficiency indicator calculation program 207. The memory 201 of the robot 101 further stores an actuator information table 208 for storing status information on the actuators 203, a sensor information table 209 for storing data acquired by the sensors 204, an action template information table 210 for storing templates of action patterns, and an action indicator information table 211 for storing action indicator items associated with individual action pattern.

The action indicators associated with an action pattern are information including indicative data acquired when the robot 101 carries out an action pattern.

Embodiment 1 provides a configuration that each robot 101 stores the aforementioned programs and information in the memory 201. However, the robot 101 in Embodiment 1 may store the aforementioned information to be stored in the memory 201 to an external storage device (not shown). The CPU 202 may retrieve necessary information from the external storage device each time of processing of the programs and further, may store the result of the processing to the external storage device each time the processing ends.

The external storage device of the robot 101 may be a large-capacity and non-volatile storage device such as a magnetic storage device (HDD) or a flash memory (SSD). The communication I/F 205 is a network interface device for controlling communication with the other apparatuses in accordance with a predetermined protocol.

The programs to be executed by the CPU 202 are provided to the robot 101 through a removable medium (such as a CD-ROM or a flash memory) or a network and stored to the external storage device of a non-transitory storage medium. For this reason, it is preferable that the robot 101 have an interface for retrieving data from the removable medium.

The robot 101 may have a computer system configured with one physical computer or a plurality of logical or physical computers. The aforementioned programs may run on separate threads on the same computer or run on a virtual machine built with resources of a plurality of physical computers.

The functions of the action indicator sending program 206 and the action efficiency indicator calculation program 207 may be implemented with a physical device such as an integrated circuit. For example, the robot 101 may have an action indicator sending unit having the functions of the action indicator sending program 206.

The above-described differences in the manner of storing information do not affect the nature of this invention.

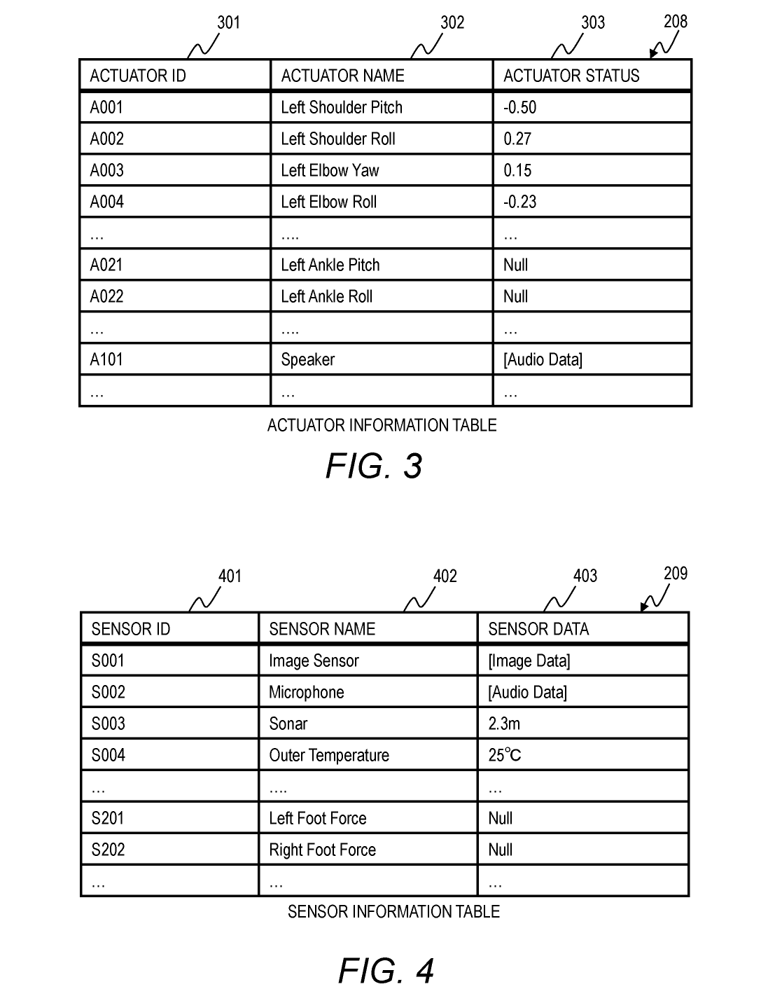

FIG. 3 is an explanatory diagram for illustrating an example of the actuator information table 208 held by a robot 101 in Embodiment 1.

The actuator information table 208 includes actuator information. The actuator information is indicative data showing the specifics of an action performed by the robot 101.

Each entry of the actuator information includes an actuator ID 301 for indicating the identifier of an actuator 203, an actuator name 302 for indicating the description of the actuator 203, and an actuator status 303 for indicating the status of the actuator 203.

The actuator ID 301 indicates an indicative data item in the actuator information and the actuator status 303 indicates an indicative data value in the actuator information.

The actuator name 302 may be the name of the part of the robot 101 to be controlled by the actuator 203. The actuator name 302 is information for convenience of explanation and management; the actuator information table 208 does not need to include actuator names 302.

The actuator status 303 in FIG. 3 shows one of the value “non-existence (null)”, a numerical value, and binary data (audio data). The value “non-existence (null)” means a status where the actuator 203 identified by the actuator ID 301 is not activated.

When the action indicator sending program 206 cannot acquire data from some actuator 203, the action indicator sending program 206 may add an entry to the actuator information and include a value “null” in the actuator status 303 and the ID of the actuator 203 from which data is not available in the actuator ID 301.

The actuator status 303 may store a value expressed in any format other than the examples shown in FIG. 3.

For example, the actuator status 303 may indicate the extent to which the actuator 203 moves a part of the robot 101 in a numerical value or indicate the substance of the audio that the actuator 203 outputs from a part of the robot 101 in binary data.

FIG. 4 is an explanatory diagram for illustrating an example of the sensor information table 209 held by a robot 101 in Embodiment 1.

The sensor information table 209 includes sensor information. The sensor information is indicative data showing physical quantities measured by the sensors 204 when the robot 101 performs an action.

Each entry of the sensor information includes a sensor ID 401 for indicating the identifier of a sensor 204, a sensor name 402 for indicating the description of the sensor 204, and sensor data 403 for indicating the data collected by the sensor 204.

The sensor ID 401 indicates an indicative data item in the sensor information and sensor data 403 indicates an indicative data value in the sensor information.

The sensor name 402 may indicate the object to be measured by the sensor 204 identified by the sensor ID 401. The sensor name 402 is information for convenience of explanation and management; the sensor information table 209 does not need to include sensor names 402.

The sensor data 403 indicates a physical quantity measured by the sensor 204. The sensor data 403 in FIG. 4 shows one of the value “non-existence (null)”, a numerical value with a unit of measurement, and binary data (such as image data or audio data). The value “non-existence (null)” means a status where the sensor 204 identified by the sensor ID 401 does not detect a value.

When the action indicator sending program 206 cannot acquire data from a sensor 204, the action indicator sending program 206 may add an entry to the sensor information and include a value “null” in the sensor data 403 and the ID of the sensor 204 from which data is not available in the sensor ID 401.

The sensor data 403 may store a value expressed in any format other than the examples shown in FIG. 4. The sensor data 403 may be image data captured by a sensor 204 or a temperature measured by a sensor 204, for example.

The actuator information table 208 in FIG. 3 and the sensor information table 209 in FIG. 4 include the latest actuator information and the latest sensor information. However, the actuator information table 208 and the sensor information table 209 may include actuator information and sensor information acquired in a certain period in the past as necessary to calculate action result information, which will be described later.

In this embodiment, the combination of actuator information and sensor information to be generated and the values of the actuator information and the sensor information to be collected are different depending on the kind of action of the robot 101. For this reason, the robot 101 and the evaluation apparatus 103 use the actuator information and the sensor information as indicative data to identify the action of the robot 101.

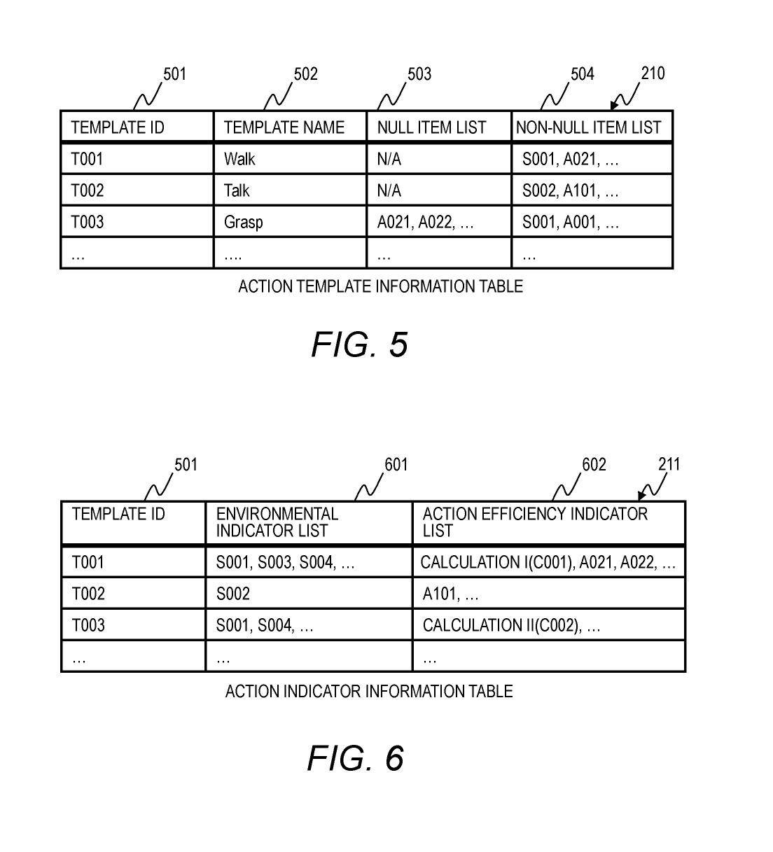

FIG. 5 is an explanatory diagram for illustrating an example of the action template information table 210 held by a robot 101 in Embodiment 1.

The action template information table 210 includes action template information. The action template information specifies combinations of indicative data (actuator information and sensor information) required to presume an action pattern of the robot 101.

Each entry of action template information includes a template ID 501, a template name 502, a null item list 503, and a non-null item list 504. The template ID 501 indicates the identifier of an action template to uniquely identify an action pattern.

The template name 502 indicates the description of the action pattern corresponding to the action template. The template name 502 may indicate the name of the action pattern of the robot 101. The template name 502 is information for convenience of explanation and management; the action template information table 210 does not need to include template names 502.

The null item list 503 indicates the items (in this example, the identifiers) of actuator information and sensor information that should not exist for the template to be a match. The non-null item list 504 indicates the items (in this example, the identifiers) of actuator information and sensor information that should exist for the template to be a match.

In FIG. 5, the entry including “T001” in the template ID 501 indicates that, when the robot 101 performs an action pattern “Walk”, sensor information or actuator information having a value “null” is not generated and sensor information Image Sensor (identified by the sensor ID S001) and actuator information Left Ankle Pitch (identified by the actuator ID A021) are generated without exception.

The robot 101 and the evaluation apparatus 103 identify actuator IDs and sensor IDs from which indicative data is generated and ungenerated according to the acquired sensor information and actuator information and compare the identified actuator IDs and sensor IDs with the action template information to presume an action pattern performed by the robot 101.

As understood from the above, the action template information defines actions of the robot 101 as action patterns that can be presumed from indicative data. The action template information in FIG. 5 is used to presume an action pattern depending on whether indicative data is generated. However, the action template information in this embodiment may be information to find a match out of the templates with other given conditions.

For example, the non-null item list 504 may specify a range of value of indicative data. The robot 101 and the evaluation apparatus 103 can presume that the action pattern of a specific entry is performed if the acquired value of indicative data is included in the range provided in the non-null item list 504 of the entry.

FIG. 6 is an explanatory diagram for illustrating an example of the action indicator information table 211 held by a robot 101 in Embodiment 1.

The action indicator information table 211 includes action indicator information. The action indicator information specifies indicative data to be sent to the evaluation apparatus 103 by action pattern.

Each entry of action indicator information includes a template ID 501, an environment indicator list 601, and an action efficiency indicator list 602. The template ID 501 indicates the identifier of an action template to uniquely identify an action pattern.

The environment indicator list 601 specifies sensor information (environmental indicators) to be sent to the evaluation apparatus 103 when indicative data associated with the action pattern identified by the template ID 501 is acquired. The action efficiency indicator list 602 indicates action efficiency indicators to be sent to the evaluation apparatus 103 when indicative data associated with the action pattern identified by the template ID 501 is acquired.

An environmental indicator is sensor data indicating the condition of an external environment when the robot 101 performs an action. An action efficiency indicator is an amount varied with an action of the robot 101 and is data indicating the result of the action.

The action efficiency indicators listed in an entry include actuator information and further, action result information calculated based on at least one kind of actuator information or sensor information as necessary. The action result information is indicative data such as a movement distance or a heat release value of the robot 101. The action result information is calculated by the action efficiency indicator calculation program 207.

In FIG. 6, the entry including “T001” in the template ID 501 specifies that, in response to acquisition of indicative data associated with the template T001 corresponding to an action pattern “Walk”, the robot 101 sends sensor information (particularly, sensor data 403) of Image Sensor (identified by the sensor ID S001) and Sonar (identified by the sensor ID S003), and Outer Temperature (identified by the sensor ID S004) to the evaluation apparatus 103 as environmental indicators and further, sends the result of Calculation I (identifier C001) by the action efficiency indicator calculation program 207 and actuator information (particularly, actuator statuses 303) of Left Ankle Pitch (identified by the actuator ID A021) and Left Ankle Roll (identified by the actuator ID A022) to the evaluation apparatus 103 as action efficiency indicators.

The action result information is calculated by the action efficiency indicator calculation program 207 using at least one of the actuator statuses 303 and the sensor data 403 and the method specified in the action efficiency indicator list 602. The action efficiency indicator calculation program 207 may calculate the action result information using information acquired by another robot 101 or another device.

For example, the action efficiency indicator calculation program 207 may use data of a GPS sensor to calculate a moving velocity of the robot 101 as action result information.

Defining the action indicators to be sent to the evaluation apparatus 103 in the action indicator information table 211 eliminates the robot 101 to send indicative data unnecessary for evaluation to the evaluation apparatus 103, so that the required network bandwidth can be reduced.

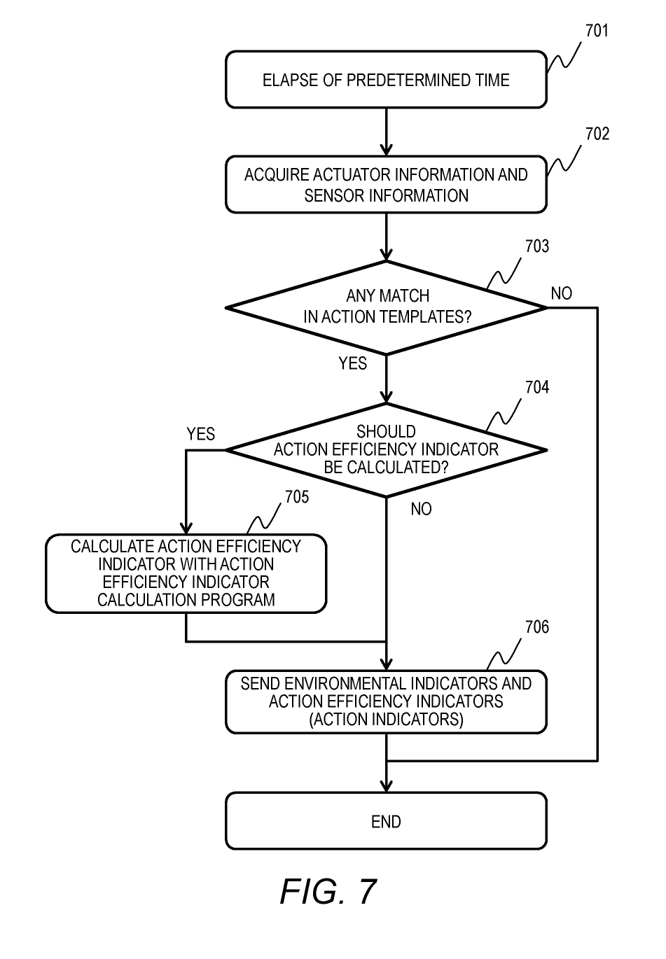

FIG. 7 is a flowchart for illustrating specific processing of the action indicator sending program of a robot 101 in Embodiment 1.

At Step 701, in response to a trigger of elapse of a predetermined time, the robot 101 invokes the action indicator sending program 206. Instead of the elapse of a predetermined time, the robot 101 may employ information such as an alarm outputted from a sensor 204 or an actuator 203 as the trigger to start the action indicator sending program 206.

After Step 701, the action indicator sending program 206 acquires the latest information (actuator statuses and sensor data) from the actuators 203 and the sensors 204 and stores the acquired information to the actuator information table 208 and the sensor information table 209 (702).

Concurrently, the action indicator sending program 206 also stores values to the actuator IDs 301, actuator names 302, sensor IDs 401, and sensor names 402 in accordance with the actuators 203 and the sensors 204 of the information sources.

In another configuration, the action indicator sending program 206 may send the latest actuator information and sensor information to the evaluation apparatus 103 as action indicators after execution of Step 702. This configuration frees the robot 101 from the need to determine an action template based on the indicative data, reducing the processing load in the robot 101. On the other hand, the evaluation apparatus 103 presumes an action pattern using the indicative data examined by the robot 101, achieving correct presumption of an action pattern for sophisticated evaluation.

In this case, the action indicators sent to the evaluation apparatus 103 include indicative data irrelevant to the action pattern. However, the evaluation apparatus 103 extracts indicative data necessary for evaluation from the received action indicators and does not use the unnecessary data in the evaluation.

After Step 702, the action indicator sending program 206 selects entries of the action template information table 210 one by one from the first entry and compares the null item list 503 and the non-null item list 504 with the actuator information table 208 and the sensor information table 209 to identify an action template matching the latest actuator information and sensor information. The action indicator sending program 206 determines whether any action template matching the latest actuator information and sensor information can be identified (703).

Specifically, the action indicator sending program 206 first identifies entries of the action template information table 210 in which the actuator IDs and sensor IDs included in the actuator information table 208 and the sensor information table 209 are included in the null item list 503 or the non-null item list 504.

Then, if the indicative data specified in the null item list 503 of an identified entry shows values of “Null” in the actuator information table 208 and the sensor information table 209 and the indicative data specified in the non-null item list 504 of the identified entry shows values other than “Null” in the actuator information table 208 and the sensor information table 209, the action indicator sending program 206 determines that the template ID 501 of the identified entry is an action template matching the latest actuator information and sensor information.

For example, the indicative data specified in the null item list 503 shows non-null values in the actuator information table 208 and the sensor information table 209, the action indicator sending program 206 does not determine that the action template of the entry including the null item list 503 is a match.

If the action indicator sending program 206 cannot find a match in the action templates, the action indicator sending program 206 terminates the processing illustrated in FIG. 7.

If the action indicator sending program 206 can identify a match in the action templates, the action indicator sending program 206 acquires the template ID 501 of the action template in the action indicator information table 211. Then, the action indicator sending program 206 determines whether the entry including the acquired template ID 501 in the action indicator information table 211 includes an item that requires calculation (for example, Calculation I in FIG. 6) in the action efficiency indicator list 602 (704).

If the action efficiency indicator list 602 includes an item that requires calculation, the action indicator sending program 206 invokes the action efficiency indicator calculation program 207. The action efficiency indicator calculation program 207 executes calculation specified in the action efficiency indicator list 602 to obtain an action efficiency indicator (705).

If the determination at Step 704 is that the action efficiency indicator list 602 does not include an item that requires calculation, or after Step 705, the action indicator sending program 206 sends action indicators to the evaluation apparatus 103 through the communication I/F 205 and the communication media 102 (706).

The action indicators include at least a robot ID of the identifier of the individual the action indicator sending program 206 belongs to, the actuator IDs 301 and the actuator statuses 303 designated by the action template determined at Step S703, and the sensor IDs 401 and the sensor data 403 designated by the action template. The action indicators further include the identifiers and values of the action result information designated by the action template as necessary.

At Step 706, the action indicator sending program 206 extracts the actuator IDs 301 and actuator statuses 303 designated by the action template from the actuator information table 208 and extracts the sensor IDs 401 and sensor data 403 designated by the action template from the sensor information table 209 to include them to the action indicators.

After Step 706, the action indicator sending program 206 terminates the processing.

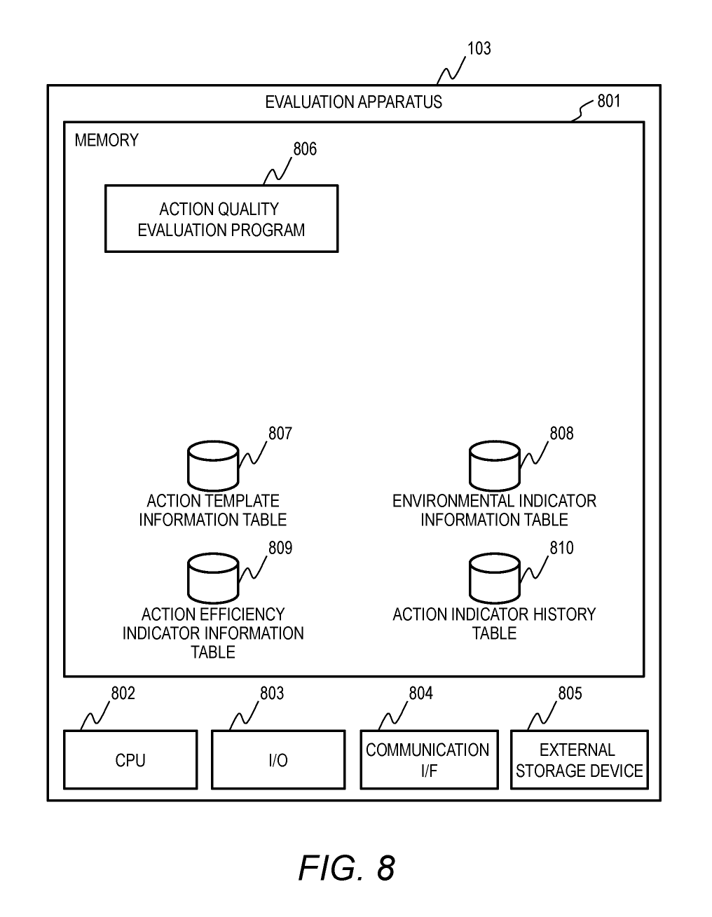

FIG. 8 is a block diagram for illustrating a configuration of the evaluation apparatus 103 in Embodiment 1.

The evaluation apparatus 103 includes a computer having a CPU 802, a memory 802, and an external storage device 805.

The functions of the evaluation apparatus 103 in Embodiment 1 are stored in the external storage device 805 of the computer as program software. In starting the functions, the CPU 802 deploys the program software on the memory 801 and executes the program software.

The evaluation apparatus 103 connects to the communication media 102 and the display apparatus 104 through at least either one of an input and output (I/O) interface 803 and a communication interface (I/F) 804.

The memory 801 includes a ROM of a non-volatile storage element and a RAM of a volatile storage element. The ROM stores programs that will not be altered (for example, the BIOS). The RAM is a high-speed and volatile storage element like a DRAM (Dynamic Random Access Memory) and stores programs and data to be used to execute the programs stored in an auxiliary storage device on a temporary basis.

The memory 801 stores an action quality evaluation program 806. The memory 801 further stores an action template information table 807 for storing templates of action patterns, an environmental indicator information table 808 for storing environmental indicators associated with individual action patterns, an action efficiency indicator information table 809 for storing action efficiency indicators associated with individual action patterns, and an action indicator history table 810 for storing action indicators received in the past.

This embodiment provides a configuration where the aforementioned programs and information are stored in the memory 801 of a single computer. However, another configuration can be employed where the aforementioned information is stored in the external storage device 805, retrieved from the external storage device 805 each time of processing of the programs, and further, stored to the external storage device 805 each time the processing ends.

In still another configuration, the aforementioned programs and information can be distributed and stored in a plurality of computers. For example, the aforementioned information may be implemented as relational database tables and stored in a database server different from the evaluation apparatus 103 and the aforementioned programs run on the evaluation apparatus 103 may reference or update the information in the database server. Such differences in the manner of storing information as described above do not affect the nature of this invention.

The external storage device 805 may be a large-capacity and non-volatile storage device such as a magnetic storage device (HDD) or a flash memory (SSD). The I/O interface 803 is a network interface device for make communication in accordance with a predetermined protocol. The communication I/F 205 is a network interface device for controlling communication with the other apparatuses in accordance with a predetermined protocol.

The action template information table 807 held by the evaluation apparatus 103 can be in the same or a different format from the action template information tables 210 held by the robots 101 as far as the table 807 includes information corresponding to the null item list 503 and the non-null item list 504 in the table 210. In the case of the same format, the stored information may be identical or different.

This is because the information in the action template information tables 210 held by the robots 101 does not need to be strictly synchronized with the information in the action template information table 807 held by the evaluation apparatus 103. Particularly, the character strings of the template IDs 501 do not need to be synchronized; the action template information table 807 can have any template IDs as far as the table 807 has template IDs representing the same template names 502.

The programs to be executed by the CPU 802 are provided to the evaluation apparatus 103 through a removable medium (such as a CD-ROM or a flash memory) or a network and stored to the external storage device 805 of a non-transitory storage medium. For this reason, it is preferable that the evaluation apparatus 103 have an interface for retrieving data from the removable medium.

The evaluation apparatus 103 is a computer system configured with one physical computer or a plurality of logical or physical computers. The aforementioned programs may run on separate threads on the same computer or run on a virtual machine built with resources of a plurality of physical computers.

The functions of the action quality evaluation program 806 may be implemented in the evaluation apparatus 103 with a physical device such as an integrated circuit. For example, the evaluation apparatus 103 may have an action quality evaluation unit having the functions of the action quality evaluation program 806.

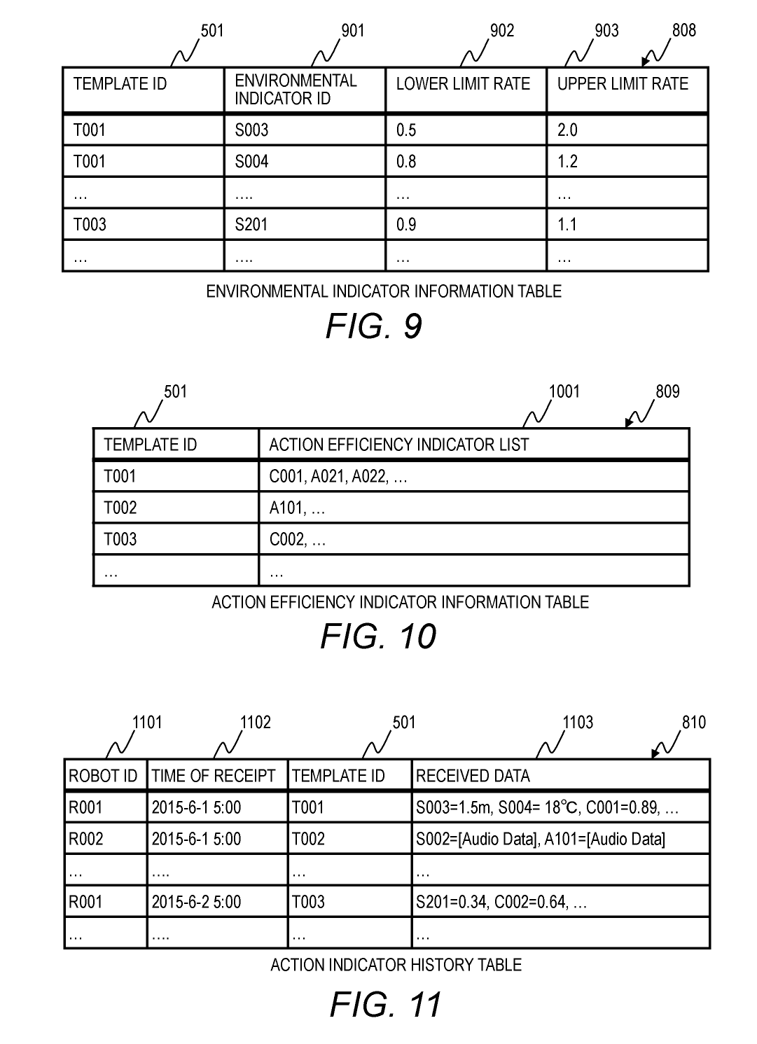

FIG. 9 is an explanatory diagram for illustrating an example of the environmental indicator information table 808 held by the evaluation apparatus 103 in Embodiment 1.

The environmental indicator information table 808 includes environmental indicator information. The environmental indicator information specifies items of sensor information required to evaluate each action pattern. The environmental indicator information further specifies value ranges of sensor data expected to be measured when each action pattern is performed in an environment (similar environment) similar among the robots 101.

With reference to the environmental indicator information, the evaluation apparatus 103 can exclude indicative data acquired about an action pattern performed in an unusual environment from the indicative data to be used for evaluation. This operation enables accurate evaluation.

An entry of the environmental indicator information includes a template ID 501 for indicating the identifier of an action template, an environmental indicator ID 901 for indicating the identifier (sensor ID) of an environmental indicator (sensor data), a lower limit rate 902 for indicating the lower threshold to determine whether the sensor data has been measured in the similar environment, and an upper limit rate 903 for indicating the upper threshold to determine whether the sensor data has been measured in the similar environment.

The environmental indicator ID 901 specifies the identifier of an environmental indicator required to evaluate the action pattern identified by the template ID 501. In other words, the environmental indicator ID 901 specifies an item of indicative data required to evaluate the action pattern. The environmental indicator information is specified in advance by an administrator or an operator.

FIG. 10 is an explanatory diagram for illustrating an example of the action efficiency indicator information table 809 held by the evaluation apparatus 103 in Embodiment 1.

The action efficiency indicator information table 809 includes action efficiency indicator information. The action efficiency indicator information specifies action efficiency indicators required to evaluate each action pattern. Each entry of the action efficiency indicator information includes a template ID 501 for indicating the identifier of an action template and an action efficiency indicator list 1001 for indicating indicative data to be used for evaluation.

The action efficiency indicator list 1001 in FIG. 10 provides actuator IDs and identifiers of action result information. In other words, the action efficiency indicator list 1001 provides items of indicative data required to evaluate an action pattern.

The action efficiency indicator information is specified in advance by an administrator or an operator. The action efficiency indicator list 1001 may include a sensor ID as necessary. In the case where the robots 101 do not calculate action result information, the action efficiency indicator list 1001 does not need to include an ID of action result information.

FIG. 11 is an explanatory diagram for illustrating an example of the action indicator history table 810 held by the evaluation apparatus 103 in Embodiment 1.

The action indicator history table 810 includes a history of action indicators. The history of action indicators provides values of indicative data acquired when the quality of action of a robot 101 is at a specified level by robot 101 and by action pattern. The specified level in Embodiment 1 means a normal level, at which the quality of action has not deteriorated.

Each record of the action indicator history includes a robot ID 1101 for indicating the identifier of the robot of data source, a time of receipt 1102 for indicating the time of receipt of the indicative data, a template ID 501 for indicating the action pattern associated with the indicative data, and received data 1101 for indicating the item and the value of the indicative data.

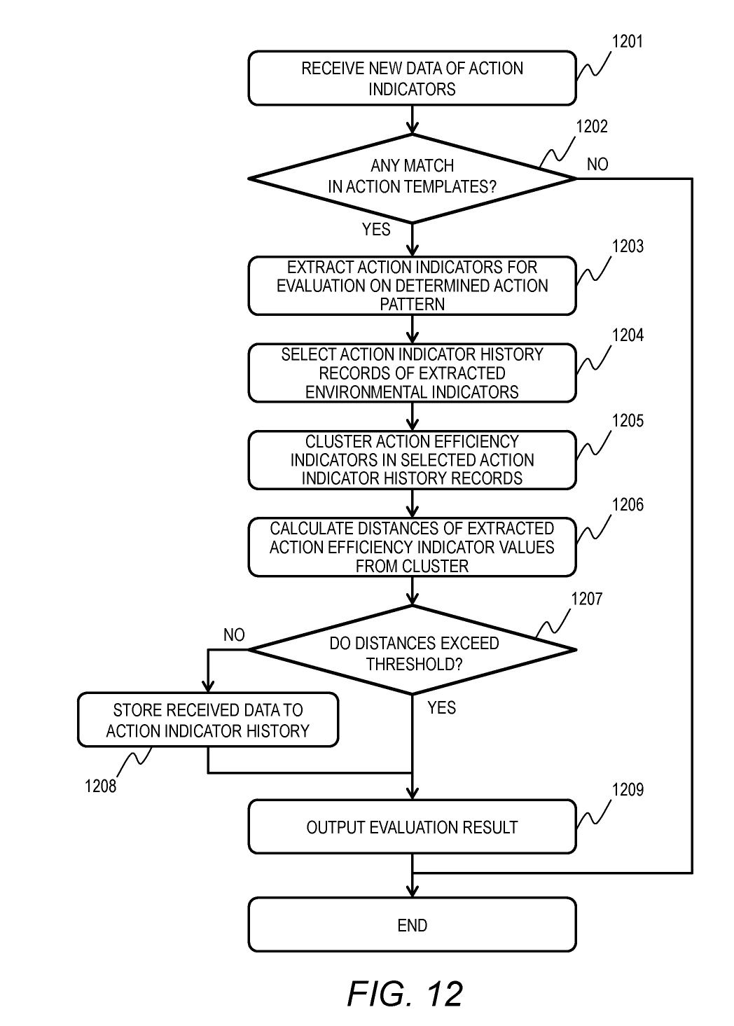

The action indicator history in FIG. 11 includes indicative data with which the later-described processing illustrated in FIG. 12 has determined that the quality of action has not deteriorated. The entries are added and updated through the processing in FIG. 12. However, the action indicator history in this embodiment may be specified in advance by the administrator or the operator or alternatively, may include indicative data evaluated in the past together with indicative data specified by the administrator or the operator.

FIG. 12 is a flowchart for illustrating specific processing of the action quality evaluation program 806 in the evaluation apparatus 103 in Embodiment 1.

At Step 1201, in response to a trigger of receipt of new action indicators, the CPU 802 of the evaluation apparatus 103 starts the action quality evaluation program 806. In the case of receipt of action indicators through a storage medium, the evaluation apparatus 103 can also regard the receipt of the storage medium as receipt of action indicators to start the action quality evaluation program 806.

Further at Step 1201, the action quality evaluation program 806 stores the received action indicators to the memory 801 and further, to the external storage device 805 as necessary.

After Step 1201, the action quality evaluation program 806 selects entries of the action template information table 807 one by one from the first entry and compares the null item list and the non-null item list with the indicative data of the received action indicators to identify an action template matching the indicative data of the received action indicators. Then, the action quality evaluation program 806 determines whether any action template matching the received action indicators can be identified (1202).

Step 1202 uses the same identification method as Step 703. Specifically, the action quality evaluation program 806 identifies an action template including indicative data items showing null values and indicative data items showing non-null values in the received action indicators in the null item list and the non-null item list, respectively, as a match.

In this connection, the action template information table 807 may include an identifier of action result information in the null item list and/or the non-null item list. The action quality evaluation program 806 may therefore determine an action template depending on whether the identifier of action result information included in the received action indicators is included in the action template information table 807.

At Step 1202, the action quality evaluation program 806 determines whether the action indicators received from a robot 101 include indicative data specified in the action template information table 807 and determines an action template using the results to presume an action pattern of the robot 101.

Since the action quality evaluation program 806 executes Step 1202 to presume an action pattern in accordance with the items of the sensor information and actuator information (and action result information) generated when the robot 101 performs an action, the template IDs do not need to be synchronized among the robots 101 and the evaluation apparatus 103. Accordingly, even if at least one of the robots 101 and the evaluation apparatus 103 makes a configuration change, the action quality evaluation program 806 can correctly presume the action.

If the action quality evaluation program 806 cannot determine an action template matching the received action indicators, the program 806 terminates the processing.

If the action quality evaluation program 806 can determine an action template matching the received action indicators, the program 806 extracts indicative data required for evaluation on the action pattern of the identified action template from the received action indicators with reference to the environmental indicator information table 808 and the action efficiency indicator information table 809 (1203).

Specifically, the action quality evaluation program 806 acquires the items of environmental information (sensor IDs) required for the evaluation from the environmental indicator IDs 901 associated with the template ID 501 of the determined action template from the environmental indicator information table 808. Furthermore, the action quality evaluation program 806 acquires the items of action efficiency indicators (actuator IDs and/or the identifier of action result information) required for the evaluation from the action efficiency indicator list 1001 associated with the template ID 501 of the determined action template from the action efficiency indicator information table 809.

The action quality evaluation program 806 extracts indicative data identified by at least either the acquired environmental indicator IDs 901 or the acquired items in the action efficiency indicator list 1001 from the received action indicators. As a result, the action quality evaluation program 806 can extract indicative data required for evaluation on the presumed action pattern from the received action indicators.

After Step 1203, the action quality evaluation program 806 selects history records of action indicators (history data A) which are history records of action indicators acquired when the action pattern presumed at Step 1202 is performed in the similar environment and the quality of the presumed action pattern is determined to be at a specified level (normal level in Embodiment 1) from the action indicator history table 810 (1204).

Specifically, the action quality evaluation program 806 acquires the entries of the environmental indicator information table 808 associated with the template ID 510 of the action template determined at Step 1202. Each of the acquired entries of the environmental indicator information table 808 indicates a value range for the sensor data expected to be measured when the action pattern presumed at Step 1202 is performed in the similar environment.

The action quality evaluation program 806 uses the environmental indicator IDs 901, the upper limit rates 903, and the lower limit rates 902 of the acquired entries as filters to select entries including indicative data (environmental indicators: sensor information) satisfying the upper limit rates 903 and the lower limit rates 902 from the action indicator history table 810 as history data A.

The indicative data satisfying an upper limit rate 903 and a lower limit rate 902 means sensor information showing values within the range specified with the upper limit rate 903 and the lower limit rate 902.

The administrator or operator can specify any value range for each environmental indicator in the environmental indicator information table 808 to define the similar environment. Accordingly, Step 1204 of selecting history data A with reference to the environmental indicator information table 808 enables the action quality evaluation program 806 to use a history of action indicators of an action pattern acquired when the action pattern has been performed in the environment satisfying the criteria specified by the administrator in the comparison with the received action indicators.

The action quality evaluation program 806 can exclude action indicator history records acquired in environments that are not suitable for comparison, achieving more accurate evaluation.

After Step 1204, the action quality evaluation program 806 evaluates the quality of the presumed action pattern based on the result of comparison of the indicative data extracted at Step 1203 with the history data A. The action quality evaluation program 806 in Embodiment 1 uses the distance between the history data A and the extracted indicative data in the comparison from Step 1205 to Step 1207 to evaluate the quality of the presumed action pattern.

At Step 1205, the action quality evaluation program 806 acquires the action efficiency indicator list 1001 associated with the template ID 510 of the action template identified at Step 1202 from the action efficiency indicator information table 809.

The action quality evaluation program 806 creates a multidimensional space having axes of indicators (that is, the indicative data extracted at Step 1203) in the acquired action efficiency indicator list 1001 and clusters the selected history data A in this multidimensional space (1205). The number of dimensions of the multidimensional space to be created at this step is equal to the number of indicative data items in the acquired action efficiency indicator list 1001.

The number of clusters to be created at this step may be one or more. The method of clustering may be a known method such as k-means clustering. Clustering at Step 1205 enables the action quality evaluation program 806 to compare the action indicators including indicative data on a plurality of items with a history of a combination of a plurality of action indicators at a later step, achieving accurate evaluation.

After Step 1205, the action quality evaluation program 806 calculates the distances of the values of action efficiency indicators extracted at Step 1203 and at least one cluster in the multidimensional space created at Step 1204 and selects the shortest distance among the calculated distances (1206).

After Step 1206, the action quality evaluation program 806 compares the shortest distance with a predetermined threshold to determine whether the shortest distance exceeds the predetermined threshold (1207). If the shortest distance exceeds the predetermined threshold, the action quality evaluation program 806 in Embodiment 1 determines that the combination of action efficiency indicators are off from the normal values and outputs an evaluation result that the quality of action of the robot 101 of the action indicator source has deteriorated and the action is abnormal to the display apparatus 104 (1209).

If the determination at Step 1208 is that the shortest distance does not exceed the predetermined threshold, the action quality evaluation program 806 in Embodiment 1 determines that the action efficiency indicators are within normal values. The action quality evaluation program 806 stores the received action indicators and the template ID of the corresponding action template to the action indicator history table 810 (1208).

This operation enables the action indicator history table 810 to hold the latest action indicators acquired at the normal level. Each time the action quality evaluation program 806 performs the processing in FIG. 12, the program 806 increases the data held in the action indicator history table 810 to raise the accuracy of the processing.

After Step 1208, the action quality evaluation program 806 outputs an evaluation result that the quality of action of the robot 101 of the action indicator source has not deteriorated and at the normal level to the display apparatus 104 and terminates the processing.

For example, the action quality evaluation program 806 outputs data for displaying the robot ID, the time of evaluation, and the calculated distances, and the evaluation result to the display apparatus 104.

As understood from the above description of Embodiment 1, in the system including a plurality of robots 101 and an evaluation apparatus 103 for evaluating the quality of action, each robot 1 sends action indicators including environmental indicators and action efficiency indicators to the evaluation apparatus 103. The evaluation apparatus 103 checks whether a specific combination of indicative data is included and a specific combination of indicative data is not included in the action indicators received from the robot 101 by comparing the indicative data with action templates to presume an action pattern.

The action quality evaluation program 806 extracts environmental indicators and action efficiency indicators to be used for evaluation in accordance with the presumption, selects history records of the action indicators in the similar environment from the history of previously received data based on the extracted environmental indicator items, clusters the selected history records of the action indicators in a multidimensional space having axes of the extracted operation efficiency indicators, and determines whether the quality of action of the robot 101 has deteriorated based on the shortest distance among the distances between the extracted individual action efficiency indicators (and environment indicators as necessary) and the cluster.

Since the action quality evaluation program 806 in Embodiment 1 uses only the indicative data involved with an action pattern to evaluate the quality of action when the robot 101 performs the particular action pattern, the action quality evaluation program 806 can remove the noise generated by using irrelevant information as evaluation parameters.

For example, to evaluate an action pattern that a humanoid robot 101 rotates an arm, the indicative data required for the evaluation can be the rate of rotation of the shoulder acquired by the actuator 203 of the shoulder. Indicative data that is not affected by rotating an arm, such as heat release values of the legs, is not necessary.

For this reason, the action quality evaluation program 806 in Embodiment 1 eliminates the indicative data showing the heat release values of the legs as noise; accurate evaluation is achieved.

Clustering only the action indicator history involved with the action pattern leads to creating a compact cluster, enabling detection of deterioration in quality of action that has been difficult to be detected. The detection of deterioration in quality of action of the robot 101 can be sophisticated.

The robot 101 checks whether the actuator information from the actuators 203 and the sensor information from the sensors 204 include a specific combination of indicative data and do not include a specific combination of indicative data with reference to the templates held by the robot 101 to presume an action pattern of the robot 101. The robot 101 sends action indicators including only the indicative data on the specific combination of indicative data to the evaluation apparatus 103, based on the result of presumption.

This configuration allows the robot 101 to collect only the indicative data required for evaluation and send the indicative data to the evaluation apparatus 103 only when the robot 101 needs evaluation of its quality of action, achieving saving of the computing resources and the communication resources used for evaluation of the quality of action. Accordingly, constant evaluation of the quality of action becomes available.

The action quality evaluation program 806 in Embodiment 1 uses a history of action indicators previously collected and showing no deterioration as the reference for evaluation. Other than the history of action indicators collected with actual actions, deterioration criteria specified by the manufacturer or history data of pseudo actions created through simulation can be used.

In the case of using specified deterioration criteria, the action quality evaluation program 806 does not need to perform the processing of Steps 1204 to 1206. The program 806 can compare the indicative data on the action indicators extracted at Step 1203 with the deterioration criteria (thresholds) to evaluate the quality of action.

The above-described action quality evaluation program 806 determines whether the quality of action has deteriorated; however, the evaluation apparatus 103 in this embodiment can evaluate the quality of action at any level by selecting the quality level to include records in the action indicator history table 810.

The above-described action quality evaluation program 806 first clusters history data A at Step 1205 and then calculates the distances between extracted indicative data and the cluster. However, if the history data A has a small number of entries, the action quality evaluation program 806 may calculate the distances without clustering the history data A.

The above-described action quality evaluation program 806 performs clustering and comparison with the cluster based on only the action efficiency indicators extracted from the received action indicators. However, the action quality evaluation program 806 may use environmental information (sensor information) included in the received action indicators as necessary in the clustering and the comparison with the cluster.

### Embodiment 2

The processing in Embodiment 2 is processing in a system including a plurality of vehicles and an evaluation apparatus for evaluating the quality of action of each vehicle. The evaluation apparatus in Embodiment 2 acquires action indicators of each vehicle through communication media. The evaluation apparatus compares the values of specific items of the acquired action indicators with templates held by the evaluation apparatus in advance to presume an action pattern of the vehicle. The evaluation apparatus selects an action quality evaluation algorithm in accordance with the presumed action pattern and evaluates the quality of action of the vehicle using the selected algorithm.

Embodiment 2 uses a different algorithm suitable to check for deterioration in quality of action of the parts involved in an action pattern of a vehicle for each action of a vehicle to achieve sophisticated evaluation.

The action quality evaluation program 806 in Embodiment 1 changes indicative data to be used for evaluation in accordance with the presumed action to change the evaluation method by changing the parameters. However, the action quality evaluation program in Embodiment 2 changes the evaluation method by changing the algorithm in accordance with the presumed action. This is the difference from the action quality evaluation program in Embodiment 1.

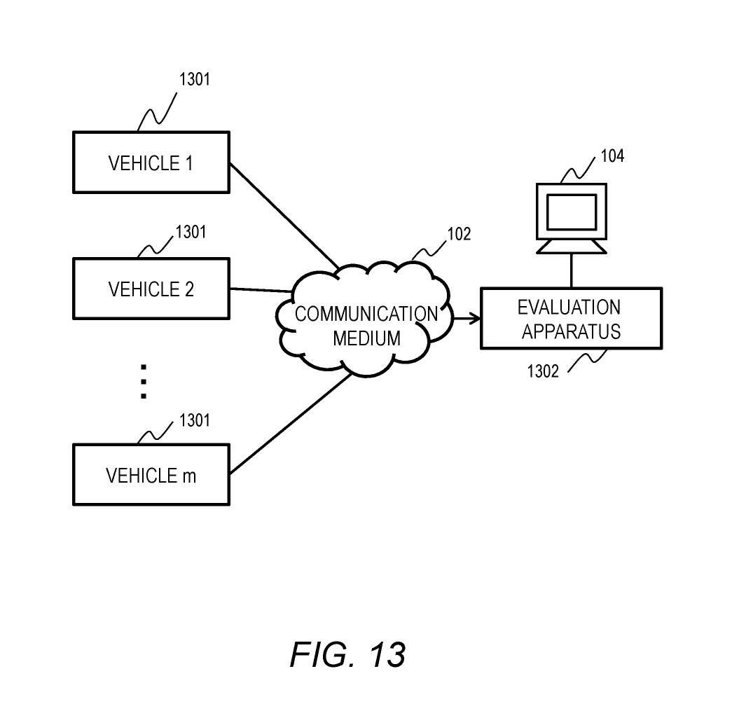

FIG. 13 is an explanatory diagram for illustrating a configuration of the evaluation system in Embodiment 2.

In this section, the description about the portions common to Embodiment 1 and Embodiment 2 is omitted.

The evaluation system in Embodiment 2 includes a plurality of vehicles 1301, communication media 102, an evaluation apparatus 1302, and a display apparatus 104. The communication media 102 and the display apparatus 104 in Embodiment 2 are the same as the communication media 102 and the display apparatus 104 in Embodiment 1.

The vehicles 1301 in Embodiment 2 correspond to the robots 101 in Embodiment 1 and are IoT devices that perform actions. Each vehicle 1301 has the same configuration and the same functions as each robot 101.

Specifically, the vehicle 1301 includes a memory 201, a CPU 202, actuators 203, sensors 204, and a communication I/F 205 as shown in FIG. 2. The programs and information to be deployed to the memory 201 of the vehicle 1301 are the same as the programs and information in the memory 201 in FIG. 2.

The actuators of the vehicle 1301 are devices included in a typical vehicle, such as an engine, a brake, and wheels.

The evaluation apparatus 1302 in Embodiment 2 corresponds to the evaluation apparatus 103 in Embodiment 1. The differences between the evaluation apparatus 1302 and the evaluation apparatus 103 are described hereinafter.

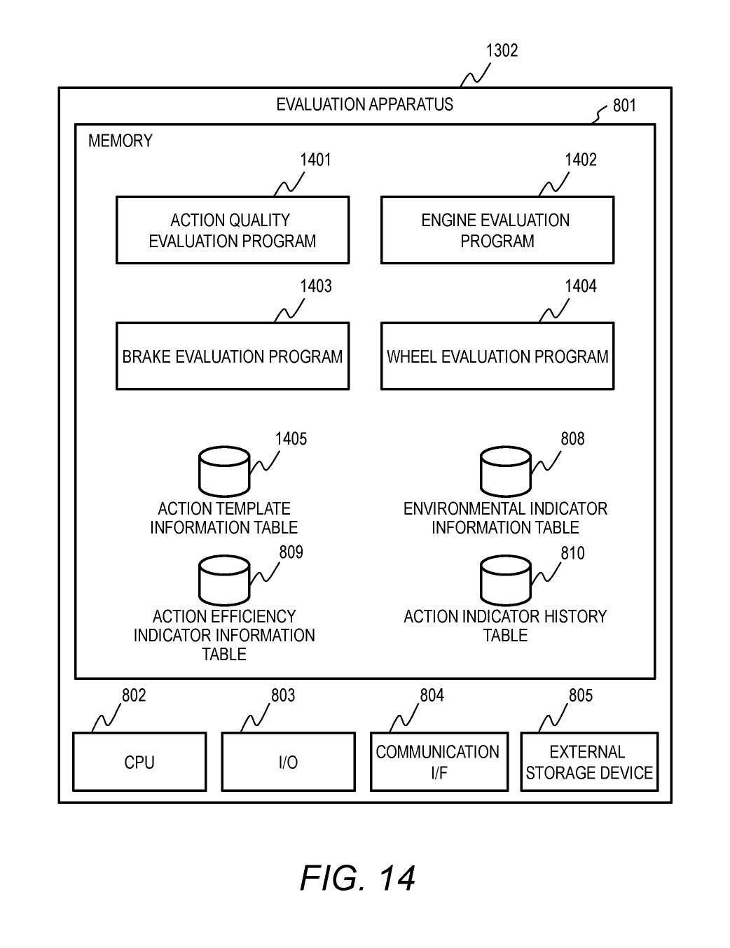

FIG. 14 is a block diagram for illustrating a configuration of the evaluation apparatus 1302 in Embodiment 2.

Description of the elements common to the evaluation apparatuses 103 and 1302 is omitted. The evaluation apparatus 1302 includes a memory 801, a CPU 802, an I/O interface 803, a communication I/F 804, and an external storage device 805, like the evaluation apparatus 103. The memory 801 of the evaluation apparatus 1302 holds an environmental indicator information table 808, an action efficiency indicator information table 809, and an action indicator history table 810, like the evaluation apparatus 103.

The memory 801 of the evaluation apparatus 1302 holds an action quality evaluation program 1401 for evaluating the quality of action and an action template information table 1405 for storing templates of action patterns, like in Embodiment 1. However, the action quality evaluation program 1401 is different from the action quality evaluation program 806 in Embodiment in the processing. The action template information table 1405 is different from the action template information table 807 in Embodiment 1 in the information therein.

The memory 801 of the evaluation apparatus 1302 further holds programs having a plurality of kinds of evaluation algorithms, unlike the memory 801 in Embodiment 1. The algorithms for executing evaluation shown in FIG. 14 are examples; they are an engine evaluation program 1402, a brake evaluation program 1403, and a wheel evaluation program 1404.

The engine evaluation program 1402 evaluates the quality of action of the engine of each vehicle 1301. The brake evaluation program 1403 evaluates the quality of action of the brake of each vehicle 1301. The wheel evaluation program 1404 evaluates the quality of action of the wheels of each vehicle 1301.

Like in Embodiment 1, the functions of the programs stored in the memory 801 in Embodiment 2 may be implemented in the evaluation apparatus 1302 with a physical integrated circuit. Specifically, the evaluation apparatus 1302 may have an action quality evaluation unit having the functions of the action quality evaluation program 1401 and an engine evaluation unit having the functions of the engine evaluation program 1402.

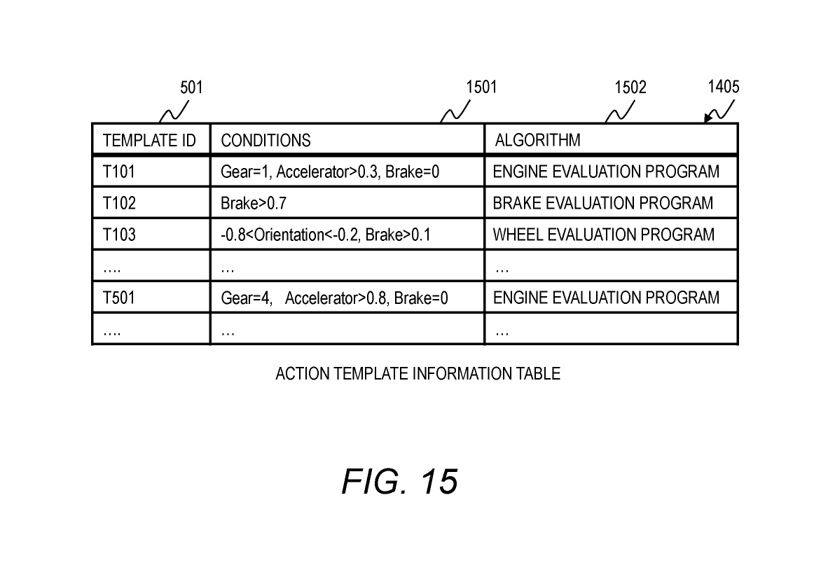

FIG. 15 is an explanatory diagram for illustrating an example of the action template information table 1405 held by the evaluation apparatus 1302 in Embodiment 2.

The action template information table 1405 includes action template information in Embodiment 2. The action template information in Embodiment 2 specifies values to be taken by indicative data that is generated when the action pattern represented by each action template is performed and an algorithm for evaluating the action pattern of the action template.

Each entry of action template information includes a template ID 501 for indicating the identifier of an action template, conditions 1501 for indicating the conditions on the values of indicative data associated with the action template, and an algorithm 1502 for indicating the evaluation algorithm to be used for evaluation on the action pattern corresponding to the action template.

The conditions 1501 in FIG. 15 indicate whether each kind of indicative data takes a value of the integer or a value included in the range of [−1, 1]. The conditions 1501 may indicate any other range. Otherwise, the conditions 1501 may indicate a part of the binary data of audio data to provide a value of indicative data which is generated when an action pattern is performed.

The algorithm 1502 indicates one of the evaluation execution algorithms included in the memory 801 of the evaluation apparatus 1302.

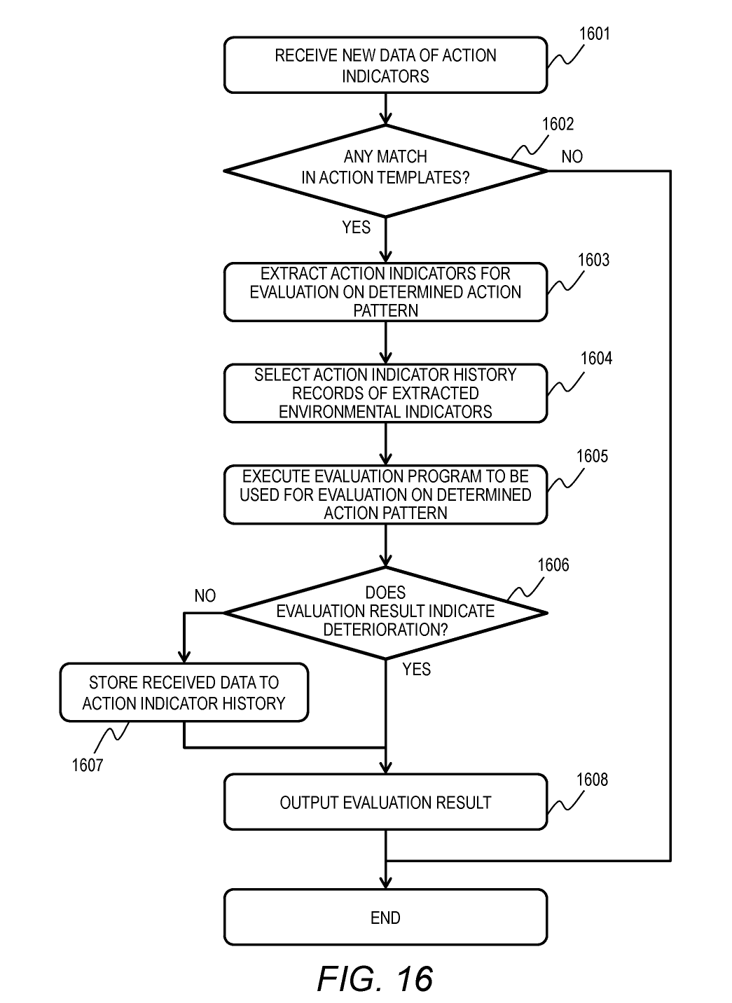

FIG. 16 is a flowchart for illustrating specific processing of the action quality evaluation program 1401 to be executed by the evaluation apparatus 1302 in Embodiment 2.

At Step 1601, in response to a trigger of receipt of new action indicators, the evaluation apparatus 1302 starts the action quality evaluation program 1401 like at Step 1201. Further at Step 1601, the action quality evaluation program 806 stores the received action indicators to the memory 801 and to the external storage device 805 as necessary.

After Step 1601, the action quality evaluation program 1401 compares the ranges specified in the conditions 1501 with the values of the indicative data of the received action indicators in order from the first entry of the action template information table 1405 to identify an action template of which the values of the received action indicators match the range specified in the conditions 1501 (1602).

More specifically, the action quality evaluation program 1401 determines that a value of a received action indicator meets a condition if the value of the received action indicator is included in the range specified in the conditions 1501. In the case where the conditions 1501 specify one value, the action quality evaluation program 1401 determines that a value of a received action indicator meets the condition if the value of the received action indicator is the same as the value in the conditions 1501.

The action quality evaluation program 1401 in Embodiment 2 presumes an action pattern in accordance with the conditions on the values of the received action indicators. This configuration provides more strict limitations to the action indicators associated with an action pattern, achieving sophisticated presumption of an action pattern.

If the action quality evaluation program 1401 cannot find a match in the action templates, the program 1401 terminates the processing illustrated in FIG. 16.

If the action quality evaluation program 1401 can find a match in the action templates, the program 1401 acquires the action pattern identified by the action template matching the received action indicators as an presumed action pattern. The action quality evaluation program 1401 extracts action indicator items associated with the action template of the presumed action pattern from the action efficiency indicator information table 809 and the environmental indicator information table 808. The action quality evaluation program 1401 then extracts indicative data on the action indicators for evaluating the action pattern (presumed action pattern) when the received action indicators are generated (1603).

Specifically, the action quality evaluation program 1401 acquires environmental indicator IDs 901 associated with the template ID 501 of the action template matching the received action indicators from the environmental indicator information table 808 and further, an action efficiency indicator list 1001 associated with the template ID 501 of the same action template from the action efficiency indicator information table 809.

The action quality evaluation program 1401 extracts indicative data items (sensor IDs, actuator IDs, and/or the identifier of action result information) matching at least either the acquired environmental indicator IDs 901 or the acquired action efficiency indicator list 1001 from the received action indicators. The action quality evaluation program 1401 then extracts indicative data required for evaluation on the presumed action pattern from the received action indicators.

After Step 1603, like Step 1204 in Embodiment 1, the action quality evaluation program 1401 selects action indicator history records acquired with similar environmental indicators from the action indicator history table 810 (1604).

After Step 1604, the action quality evaluation program 1401 selects an algorithm for the action template determined at Step 1602 from the algorithms 1502 in the action template information table 1405. The action quality evaluation program 1401 executes the program corresponding to the selected algorithm (1605).

In executing the selected algorithm, the action quality evaluation program 1401 uses the indicative data on the action indicators extracted at Step 1603. Furthermore, the action quality evaluation program 1401 may use the action indicator history records selected at Step 1604 as necessary in accordance with the selected algorithm.

Evaluating the quality of action with the selected algorithm enables the action quality evaluation program 1401 to obtain an accurate evaluation result in accordance with an algorithm suitable for the presumed action.

The action quality evaluation program 1401 determines whether the vehicle 1301 has deteriorated in quality of action in view of the result of execution of the evaluation algorithm (1606).

For example, if the action indicators received from a vehicle 1301 indicate (Gear=1, Accelerator=0.6, Brake=0), the received action indicators match the action template T101.

The action quality evaluation program 1401 accordingly acquires the action pattern identified by the action template T101 as a result of presumption and further, executes the engine evaluation program associated with the action template T101 to determine whether the engine has deteriorated in quality of action. The engine evaluation program 1402 may employ a known method as the algorithm for evaluating the engine.

If the quality of action has not deteriorated, the action quality evaluation program 1401 stores the action indicators extracted from the received data together with the template ID 501 to the action indicator history table 810 (1607). After Step 1607, or if the determination at Step 1606 is that the quality of action has deteriorated, the evaluation apparatus 1302 outputs data to display the evaluation result to the display apparatus 104 and terminates the processing (1608).

It should be noted that this invention is not limited to the above-described embodiments but includes various modifications. The above-described embodiments are explained in detail for better understanding of this invention and are not limited to those including all the configurations and elements described above. A part of the configuration of an embodiment may be replaced with a configuration of another embodiment or a configuration of an embodiment may be incorporated to a configuration of another embodiment.

The above-described configurations, functions, and processing units, for all or a part of them, may be implemented by hardware: for example, by designing an integrated circuit.

The above-described configurations and functions may be implemented by software, which means that a processor interprets and executes programs for providing the functions. The information of programs, tables, and files to implement the functions may be stored in a storage device such as a memory, a hard disk drive, or an SSD (Solid State Drive), or a storage medium such as an IC card, an SD card, or a DVD.

What is claimed is:

1. An evaluation apparatus comprising:
a processor;
a memory; and
an interface configured to receive data output by devices,
the processor being configured to:
receive action indicators including indicative data representing at least one physical quantity measured by a device and indicative data representing at least one specific of an action performed by the device through the interface;
store the received action indicators to the memory;
presume the action of the device by finding a match through comparing the received action indicators with templates each specifying a combination of items of indicative data required to presume an action of the devices;
extract indicative data required to evaluate the presumed action from the received action indicators; and
evaluate quality of the presumed action based on the extracted indicative data.

2. The evaluation apparatus according to claim 1,
wherein each of the templates includes items of indicative data to be generated in an action of the devices,
wherein the received action indicators include items of indicative data generated in an action performed by a device, and
wherein the processor is configured to presume the action of the device by determining, for each of the templates, whether the items of the indicative data included in the template are included in the received action indicators in the comparing to find a match.

3. The evaluation apparatus according to claim 2,
wherein each of the templates further specifies value ranges of indicative data to be generated in an action of the devices,
wherein the indicative data in the received action indicators is generated in an action performed by a device, and
wherein the processor is configured to presume the action of the device by determining, for each of the templates, whether values of indicative data included in the received action indicators are included in the value ranges specified by the template in the comparing to find a match.

4. The evaluation apparatus according to claim 1,
wherein the memory holds environmental information for specifying indicative data expected to be measured by the devices when the devices perform the action in a similar environment defined as being similar among the devices and an indicator history including indicative data with which the quality of the action has previously been determined to be at a specified level in the memory, and
wherein the processor is configured to:
select indicator history records including indicative data expected to be measured in the similar environment in a case where the presumed action is performed in the similar environment; and
evaluate whether the quality of the presumed action is at the specified level based on the selected indicator history records and the extracted indicative data.

5. The evaluation apparatus according to claim 4, wherein the processor is configured to:
create a multidimensional space having dimensions based on the items of indicative data required to evaluate the presumed action;
create at least one cluster by clustering the indicative data in the selected indicator history records in the multidimensional space; and
evaluate the quality of the presumed action based on distances between the at least one cluster and values of the extracted indicative data.

6. The evaluation apparatus according to claim 1,
wherein the memory holds algorithm information representing algorithms for evaluating actions, and
wherein the processor is configured to:
select an algorithm to evaluate the presumed action from the algorithm information; and
evaluate the quality of the presumed action with the extracted indicative data and the selected algorithm.

7. An evaluation system comprising:
devices; and
an evaluation apparatus configured to evaluate actions of the devices,
wherein each of the devices includes a processor and an interface for outputting data to the evaluation apparatus,
wherein each of the devices is configured to output action indicators including indicative data representing at least one physical quantity measured by the device and indicative data representing at least one specific of an action performed by the device to the evaluation apparatus through the interface of the device,
wherein the evaluation apparatus includes a processor, a memory, and an interface for receiving data output by the devices, and
wherein the evaluation apparatus is configured to:
receive the action indicators output by one of the devices through the interface of the evaluation apparatus;
store the received action indicators to the memory;
presume the action of the device by finding a match through comparing the received action indicators with templates each specifying a combination of items of indicative data required to presume an action of the devices;
extract indicative data required to evaluate the presumed action from the received action indicators; and
evaluate quality of the presumed action based on the extracted indicative data.

8. The evaluation system according to claim 7,
wherein each of the templates includes items of indicative data to be generated in an action of the devices,
wherein the received action indicators include items of indicative data generated in an action performed by one of the devices, and
wherein the evaluation apparatus presumes the action of the device by determining, for each of the templates, whether the items of the indicative data included in the template are included in the received action indicators in the comparing to find a match.

9. The evaluation system according to claim 8,
wherein each of the templates further specifies value ranges of indicative data to be generated in an action of the devices,
wherein indicative data in the received action indicators is generated in an action performed by one of the devices, and
wherein the evaluation apparatus is configured to presume the action of the device by determining, for each of the templates, whether values of indicative data included in the received action indicators are included in the value ranges specified by the template in the comparing to find a match.

10. The evaluation system according to claim 7, wherein the evaluation apparatus is configured to:
hold environmental information for specifying indicative data expected to be measured by the devices when the devices perform the action in a similar environment defined as being common to the devices and an indicator history including indicative data with which the quality of the action has previously determined to be at a specified level in the memory;
select indicator history records including indicative data expected to be measured in the similar environment in a case where the presumed action is performed in the similar environment; and
evaluate whether the quality of the presumed action is at the specified level based on the selected indicator history records and the extracted indicative data.

11. The evaluation system according to claim 10, wherein the evaluation apparatus is configured to:
create a multidimensional space having dimensions based on the items of indicative data required to evaluate the presumed action;
create at least one cluster by clustering the indicative data in the selected indicator history records in the multidimensional space; and
evaluate the quality of the presumed action based on distances between the at least one cluster and values of the extracted indicative data.

12. The evaluation system according to claim 7, wherein the evaluation apparatus is configured to:
hold algorithm information representing algorithms for evaluating actions in the memory;
select an algorithm to evaluate the presumed action from the algorithm information; and
evaluate the quality of the presumed action with the extracted indicative data and the selected algorithm.

13. A device configured to perform actions with actuators, the device comprising:
a processor;
a memory; and
an interface for outputting data to an evaluation apparatus,
wherein the device is configured to:
acquire action indicators including indicative data representing at least one physical quantity measured by the device and indicative data representing at least one specific of an action performed by the device;
store the acquired action indicators to the memory;
presume the action by finding a match through comparing the action indicators with templates each specifying a combination of items of indicative data required to presume an action;
extract indicative data required to evaluate the presumed action from the acquired action indicators; and
output the extracted indicative data to the evaluation apparatus through the interface.

14. An evaluation method for an evaluation apparatus including a processor, a memory, and an interface capable of receiving data outputted by devices, the evaluation method comprising steps of:
receiving, by the processor, action indicators including indicative data representing at least one physical quantity measured by a device and indicative data representing at least one specific of an action performed by the device through the interface;
storing, by the processor, the received action indicators to the memory;
presuming, by the processor, the action of the device by finding a match through comparing the received action indicators with templates each specifying a combination of indicative data required to presume an action of the devices;
extracting, by the processor, indicative data required to evaluate the presumed action from the received action indicators; and
evaluating, by the processor, quality of the presumed action based on the extracted indicative data.
